(19) United States
(12) Patent Application Publication
(10) Pub. No.: US 2020/0005391 A1
(43) Pub. Date: Jan. 2, 2020

(54) SYSTEM AND METHOD FOR UPDATING BIN INFORMATION

(71) Applicant: PayPal, Inc., San Jose, CA (US)

(72) Inventors: Nitin Velkur, Austin, TX (US); Chad Oliver, San Jose, CA (US); Shawn Catoe, Austin, TX (US); Sairam Manepalli, Austin, TX (US); Giribabu Govardhanan, Milpitas, CA (US)

(21) Appl. No.: 16/021,133

(22) Filed: Jun. 28, 2018

(51) Int. Cl. G06Q 40/02

(52) U.S. Cl. CPC G06Q 40/02

(57) ABSTRACT

When a BIN file is received, a first update and a second update are detected based on BIN property information corresponding to a plurality of BINs stored with the BIN file. The first update corresponds to a first BIN of the plurality of BINs, and the second update corresponds to a second BIN of the plurality of BINs. A first impact and a second impact are estimated. The first impact is associated with applying the first update corresponding to the first BIN, and the second impact is associated with applying the second update corresponding to the second BIN. Based on determining that the first impact is below a predefined threshold, the first update is automatically applied by automatically updating an electronic BIN database. Based on determining that the second impact is above the predefined threshold, additional impact analysis is performed with respect to the second update.

### BACKGROUND

### Field of the Invention

The present invention generally relates to database management, and more particularly to updating bank identification number (BIN) information within a database.

### Related Art

Electronic transactions are becoming more and more prevalent, with an ever-increasing number of online entities that may or may not have a physical real world counterpart. Furthermore, the services offered by these online entities have been improving as well. The popularity of electronic transactions is partially attributable to the ease and convenience of making a transaction electronically instead of at a physical location. To ensure the accuracy and security of the online transactions, BIN information—data pertaining to the transactions—may be stored in an electronic database, which may be managed by a third party payment provider. Partners of the third party payment provider may periodically send updates to the third party payment provider regarding the data pertaining to the transactions. However, it may be difficult for the third party payment provider to assess the impact of these updates. For example, if an update contains even a small error, it may cause a major negative impact for a larger number of customers of the third party payment provider.

Therefore, although existing systems and methods of updating BIN information have been generally adequate for their intended purposes, they have not been entirely satisfactory in every aspect. What is needed is a more granular scheme for updating the BIN information.

### BRIEF DESCRIPTION OF THE FIGURES

FIG. 1 is a block diagram of a networked system according to a various aspects of the present disclosure.

FIG. 2 is a block diagram of a system for updating BIN information according to various aspects of the present disclosure.

FIG. 3 illustrates a portion BIN file according to various aspects of the present disclosure.

FIG. 4 illustrates a tree model for analyzing a BIN update impact according to various aspects of the present disclosure.

FIG. 5 is a flowchart illustrating a method of updating BIN information according to various aspects of the present disclosure.

FIG. 6 is a flowchart illustrating a method of updating BIN information according to various aspects of the present disclosure.

FIG. 7 is an example computer system according to various aspects of the present disclosure.

FIG. 8 is a simplified example of a cloud-based computing architecture according to various aspects of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

It is to be understood that the following disclosure provides many different embodiments, or examples, for implementing different features of the present disclosure. Specific examples of components and arrangements are described below to simplify the present disclosure. These are, of course, merely examples and are not intended to be limiting. Various features may be arbitrarily drawn in different scales for simplicity and clarity.

The present disclosure pertains to a more granular and efficient scheme for updating BIN (i.e., bank identification number) information. BIN information may include information or data for conducting transactions. As non-limiting examples, BIN information may include codes that identify: a country (e.g., U.S. or U.K.), a currency (e.g., dollar or yen), a payment network (e.g., VISA™ or MASTERCARD™), a card issuer name (e.g., Bank of America™ or JPMorgan Chase™), a card level (e.g., standard or elite), a card issuer website, a card issuer phone number, or a card usage type (e.g., credit or debit).

A payment provider—such as PayPal, Inc. of San Jose, Calif.—may maintain and/or manage BIN information in one or more electronic databases. Partners of the payment provider may periodically send BIN files containing BIN updates to the payment provider. These BIN updates may include, as examples, additions of new BINs, deletions of existing BINs, or a change in property for one or more of the BINs. Conventionally, it may be difficult for a payment provider to assess the impact of the BIN updates. For example, if a BIN update contains even a small error, it may cause a major negative impact for a larger number of customers of the payment provider. One type of error may be an error in currency code. In that regard, different currencies may have their corresponding currency codes in BIN files (e.g., USD for U.S. dollars or EUR for Euros). If a currency code is incorrectly updated due to a currency code error in a BIN file, this could cause transactions for the BINs of the BIN file to undergo unneeded currency conversions, thereby incurring unnecessary costs for clients of the payment provider, or even creating legal liability for the payment provider. Consequently, when a BIN file is received, the payment provider may not instantly apply all the BIN updates of the BIN file to an electronic BIN database until all questionable updates are resolved. This is an efficient process, since a small number of questionable BIN updates can delay the application of a significantly larger number of other BIN updates. In addition, there may be conflicting updates received from different partners. Conventional BIN systems have not been able to reliably and accurately resolve these inconsistencies, which further undermines the versatility and robustness of conventional BIN systems.

The present disclosure utilizes a more granular approach to overcome the problems discussed above. When a BIN file is received, a first update and a second update are detected based on BIN property information corresponding to a plurality of BINs stored with the BIN file. The first update corresponds to a first BIN of the plurality of BINs, and the second update corresponds to a second BIN of the plurality of BINs. A first impact and a second impact are estimated. The first impact is associated with applying the first update corresponding to the first BIN, and the second impact is associated with applying the second update corresponding to the second BIN. Based on determining that the first impact is below a predefined threshold, the first update is automatically applied by automatically updating an electronic BIN database. Based on determining that the second impact is above the predefined threshold, additional impact analysis is performed with respect to the second update.

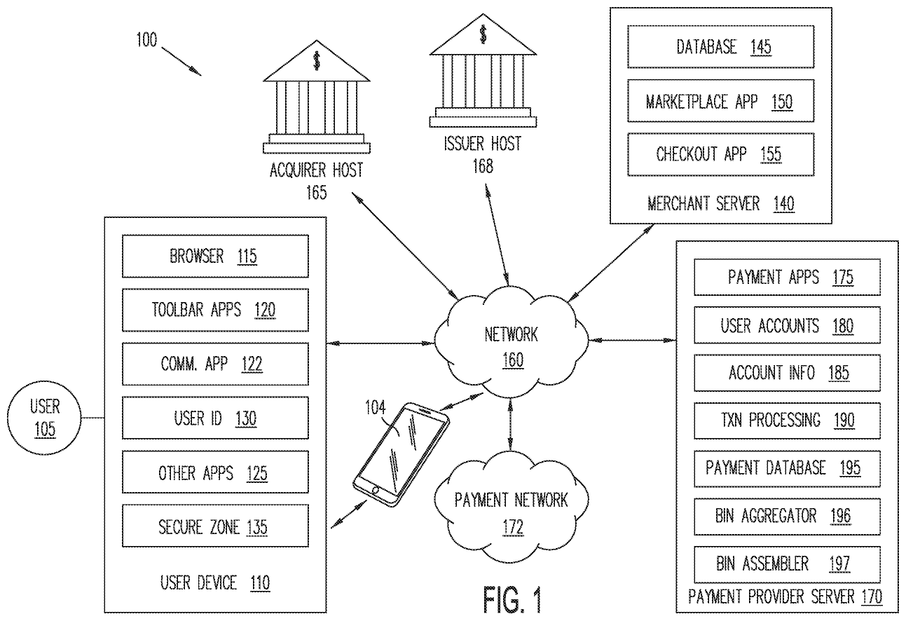

The various aspects of the present disclosure are discussed in more detail with reference to FIGS. 1-8.

FIG. 1 is a block diagram of a networked system or architecture suitable for conducting electronic online transactions according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT™ OS, a UNIX™ OS, a LINUX™ OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

The system 100 may include a user device 110, a merchant server 140, a payment provider server 170, an acquirer host 165, an issuer host 168, and a payment network 172 that are in communication with one another over a network 160. Payment provider server 170 may be maintained by a payment service provider, such as PayPal, Inc. of San Jose, Calif. A user 105, such as a consumer, may utilize user device 110 to perform an electronic transaction using payment provider server 170. For example, user 105 may utilize user device 110 to visit a merchant's web site provided by merchant server 140 or the merchant's brick-and-mortar store to browse for products offered by the merchant. Further, user 105 may utilize user device 110 to initiate a payment transaction, receive a transaction approval request, or reply to the request. Note that transaction, as used herein, refers to any suitable action performed using the user device, including payments, transfer of information, display of information, etc. Although only one merchant server is shown, a plurality of merchant servers may be utilized if the user is purchasing products from multiple merchants.

User device 110, merchant server 140, payment provider server 170, acquirer host 165, issuer host 168, and payment network 172 may each include one or more electronic processors, electronic memories, and other appropriate electronic components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160. Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, the user device may be implemented as a personal computer (PC), a smart phone, a smart phone with additional hardware such as NFC chips, BLE hardware etc., wearable devices with similar hardware configurations such as a gaming device, a Virtual Reality Headset, or that talk to a smart phone with unique hardware configurations and appropriate software, laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for online shopping and/or merchant sites for viewing and purchasing goods and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 also may include other applications to perform functions, such as email, texting, voice and IM applications that allow user 105 to send and receive emails, calls, and texts through network 160, as well as applications that enable the user to communicate, transfer information, make payments, and otherwise utilize a digital wallet through the payment provider as discussed herein.

User device 110 may include one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100. In conjunction with user identifiers 130, user device 110 may also include a secure zone 135 owned or provisioned by the payment service provider with agreement from device manufacturer. The secure zone 135 may also be part of a telecommunications provider SIM that is used to store appropriate software by the payment service provider capable of generating secure industry standard payment credentials as a proxy to user payment credentials based on user 105's credentials/status in the payment providers system/age/risk level and other similar parameters.

User device 110 may install and execute a payment application received from the payment service provider to facilitate payment processes. The payment application may allow a user to send payment transaction requests to the payment service provider, which includes communication of data or information needed to complete the request, such as funding source information.

Merchant server 140 may be maintained, for example, by a merchant or seller offering various products and/or services. The merchant may have a physical point-of-sale (POS) store front. The merchant may be a participating merchant who has a merchant account with the payment service provider. Merchant server 140 may be used for POS or online purchases and transactions. Generally, merchant server 140 may be maintained by anyone or any entity that receives money, which includes charities as well as retailers and restaurants. For example, a purchase transaction may be payment or gift to an individual. Merchant server 140 may include a database 145 identifying available products and/or services (e.g., collectively referred to as items) which may be made available for viewing and purchase by user 105. Accordingly, merchant server 140 also may include a marketplace application 150 which may be configured to serve information over network 360 to browser 115 of user device 110. In one embodiment, user 105 may interact with marketplace application 150 through browser applications over network 160 in order to view various products, food items, or services identified in database 145.

Merchant server 140 also may include a checkout application 155 which may be configured to facilitate the purchase by user 105 of goods or services online or at a physical POS or store front. Checkout application 155 may be configured to accept payment information from or on behalf of user 105 through payment provider server 170 over network 160. For example, checkout application 155 may receive and process a payment confirmation from payment provider server 170, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like.

Payment provider server 170 may be maintained, for example, by an online payment service provider which may provide payment between user 105 and the operator of merchant server 140. In this regard, payment provider server 170 may include one or more payment applications 175 which may be configured to interact with user device 110 and/or merchant server 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as credit card companies. For example, account information 185 may include private financial information of users of devices such as account numbers, passwords, device identifiers, usernames, phone numbers, credit card information (including BIN information), bank information (including BIN information), or other financial information which may be used to facilitate online transactions by user 105.

Advantageously, payment application 175 may be configured to interact with merchant server 140 on behalf of user 105 during a transaction with checkout application 155 to track and manage purchases made by users and which and when funding sources are used.

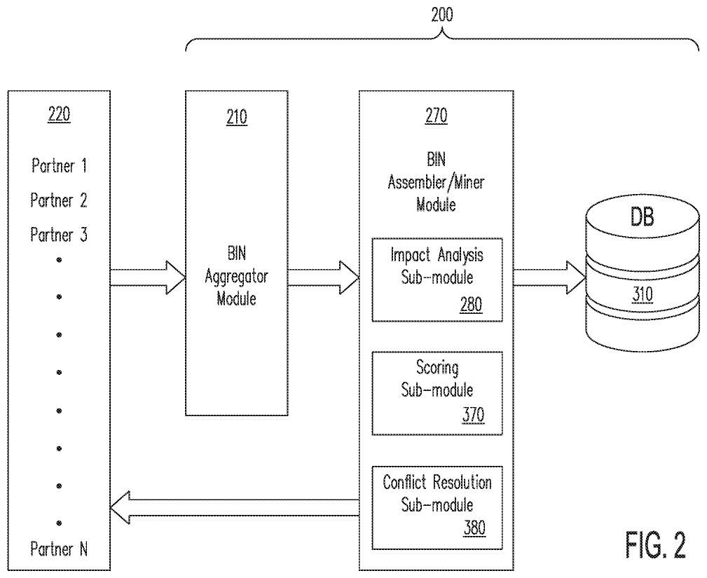

A transaction processing application 190, which may be part of payment application 175 or separate, may be configured to receive information from a user device and/or merchant server 140 for processing and storage in a payment database 195. Transaction processing application 190 may include one or more applications to process information from user 105 for processing an order and payment using various selected funding instruments, as described herein. As such, transaction processing application 190 may store details of an order from individual users, including funding source used, credit options available, etc. Payment application 175 may be further configured to determine the existence of and to manage accounts for user 105, as well as create new accounts if necessary. According to various aspects of the present disclosure, a BIN aggregator module 196 and a BIN assembler module 197 may also be implemented on the payment provider server 170. The functionalities of the BIN aggregator module 196 and the BIN assembler module 197 will be discussed below in more detail with reference to FIGS. 2-6. It is understood that although the BIN aggregator module 196 and the BIN assembler module 197 are illustrated as being separate from the transaction processing application 190 in the embodiment shown in FIG. 1, the transaction processing application 190 may implement some, or all, of the functionalities of the BIN aggregator module 196 and the BIN assembler module 197 in other embodiments. In other words, the BIN aggregator module 196 and the BIN assembler module 197 may be integrated within the transaction processing application 190 in some embodiments.

Payment network 172 may be operated by payment card service providers or card associations, such as DISCOVER™, VISA™, MASTERCARD™, AMERICAN EXPRESS™, RUPAY™, CHINA UNION PAY™, etc. The payment card service providers may provide services, standards, rules, and/or policies for issuing various payment cards. A network of communication devices, servers, and the like also may be established to relay payment related information among the different parties of a payment transaction.

Issuer host 168 may be a server operated by an issuing bank or issuing organization of payment cards. The issuing banks may enter into agreements with various merchants to accept payments made using the payment cards. The issuing bank may issue a payment card to a user after a card account has been established by the user at the issuing bank. The user then may use the payment card to make payments at or with various merchants who agreed to accept the payment card.

Acquirer host 165 may be a server operated by an acquiring bank. An acquiring bank is a financial institution that accepts payments on behalf of merchants. For example, a merchant may establish an account at an acquiring bank to receive payments made via various payment cards. When a user presents a payment card as payment to the merchant, the merchant may submit the transaction to the acquiring bank. The acquiring bank may verify the payment card number, the transaction type and the amount with the issuing bank and reserve that amount of the user's credit limit for the merchant. An authorization will generate an approval code, which the merchant stores with the transaction.

FIG. 2 is a simplified block diagram illustrating a system 200 for updating BIN information according to various aspects of the present disclosure. In some embodiments, the system 200 may be operated and/or maintained by the payment provider. The system 200 includes a BIN aggregator module 210. In some embodiments, the BIN aggregator module 210 is an embodiment of the BIN aggregator module 196 of FIG. 1. In other embodiments, the BIN aggregator module 210 is integrated within the transaction processing application 190 of FIG. 1. As shown in FIG. 2, the BIN aggregator module 210 comprises one or more interfaces for communicating with a plurality of partners 220 (e.g., partner 1, partner 2 . . . partner N) of the payment provider discussed above in association with FIG. 1. The partners 220 gather BIN data through various transactions in which they participate. As non-limiting examples, one or more of the partners 220 may include the merchant server 140, the acquirer host 165, the issuer host 168, or entities operating the payment network 172. Via a BIN loader module (not specifically illustrated herein but is configured to interface with the partners 220), the payment provider may receive BIN files sent by the partners 220 periodically or at various times. Thus, each of the partners 220 may be a source of BIN information and may be referred to as sources for collecting/supplying BIN information.

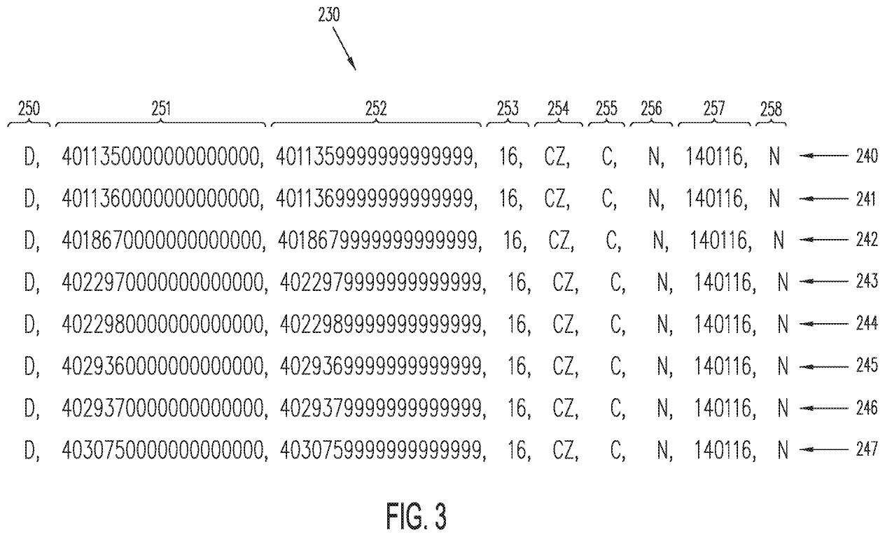

FIG. 3 shows a portion of a non-limiting example BIN file 230. The BIN file 230 may be a text document (e.g., a “txt” file) containing alphanumeric characters in some embodiments. As shown in FIG. 3, the BIN file 230 includes a plurality of BINs 240-247, which are arranged into rows of the alphanumeric characters. It is understood that the BIN file 230 may include additional BINs, but these additional BINs are not specifically illustrated herein for reasons of simplicity. Each of the BINs 240-247 comprises a plurality of fields that are separated from each other by commas, for example fields 250-258. Again, it is understood that the fields 250-258 may constitute only a portion of the BINs 240-247, and that in other embodiments, each BIN may include additional fields or fewer fields than what is shown in FIG. 3, or different fields altogether.

Still referring to FIG. 3, some of the fields 250-258 may correspond to different properties of the BIN. For example, the field 250 may include a constant letter D. The field 251 may include a series of numbers that indicate a lower limit of a BIN range (e.g., minimum account number in BIN range). The field 252 may include a series of numbers that indicate an upper limit of the BIN range (e.g., maximum account number in BIN range). The field 253 may include numbers that indicate a maximum primary account number (PAN) length (e.g., 00 through 19). The field 254 may include letters that correspond to a method of payment (e.g., CZ for credit or CR for signature debit/prepaid). The field 255 may include a letter that corresponds to a card product indicator (e.g., C for consumer credit, S for small business, etc.). The field 256 may include a number that corresponds to a PIN capability (e.g., P for P required, N for PIN not allowed, O for PIN optional). The field 257 may include numbers that indicate the BIN update date, for example a six-digit number in a YYMMDD (year/month/date) format. The field 258 may include a letter that indicates the consumer digital payment token indicator (e.g., Y for yes or N for No). Again, it is understood that the fields 250-258 are merely non-limiting examples, and additional fields may be included for each BIN, such as fields corresponding to a country code or to a type of payment card service provider or card association (e.g., VISA™ or DISCOVER™).

Referring back to FIG. 2, the partners 220 may periodically or at other times send BIN files such as the BIN file 230 to the payment provider. When the BIN aggregator module 210 receives a new BIN file from a partner, it may compare the newly received BIN file with a previous version of the BIN file. For example, suppose on day 1, a partner sends a BIN file to the payment provider. The BIN file has 100 bins, where each of the bins has 20 different BIN properties. On day 7, the same partner sends a new BIN file to the payment provider. According to the various aspects of the present disclosure, the BIN aggregator module 210 will compare the previous BIN file with the newly received BIN file to determine what changes were made between the previous version of the BIN file and the newly received BIN file. In some embodiments, the comparison includes a line-by-line comparison. Based on the comparison, the BIN aggregator module 210 may determine that the new BIN file added 10 more BINs, deleted 5 existing BINs, and changed at least one BIN property for 7 other BINs. The BIN aggregator module 210 will compile these updates into an output file. Rather than sending the entire new BIN file to a subsequent module for analysis, the present disclosure utilizes the BIN aggregator module 210 to send only the “changes” or “updates” (from the old and new BIN files) to a subsequent module—BIN assembler/miner module 270—for further processing, as discussed below in more detail. It is understood that in some embodiments, the BIN assembler module 270 is an embodiment of the BIN assembler module 197 of FIG. 1. In other embodiments, the BIN assembler module 270 is integrated within the transaction processing application 190 of FIG. 1.

Further, in certain embodiments where multiple partners each send BIN files to the system 200, the BIN aggregator module 210 may compare each newly received BIN file not only against the previous version of the BIN file from that partner, but against the BIN files received from one or more other partners as well. For example, the BIN aggregator module 210 may combine the data from different BIN files received from different partners 220 to generate a more comprehensive BIN dataset, and then compare the newly received BIN file against the more comprehensive BIN dataset.

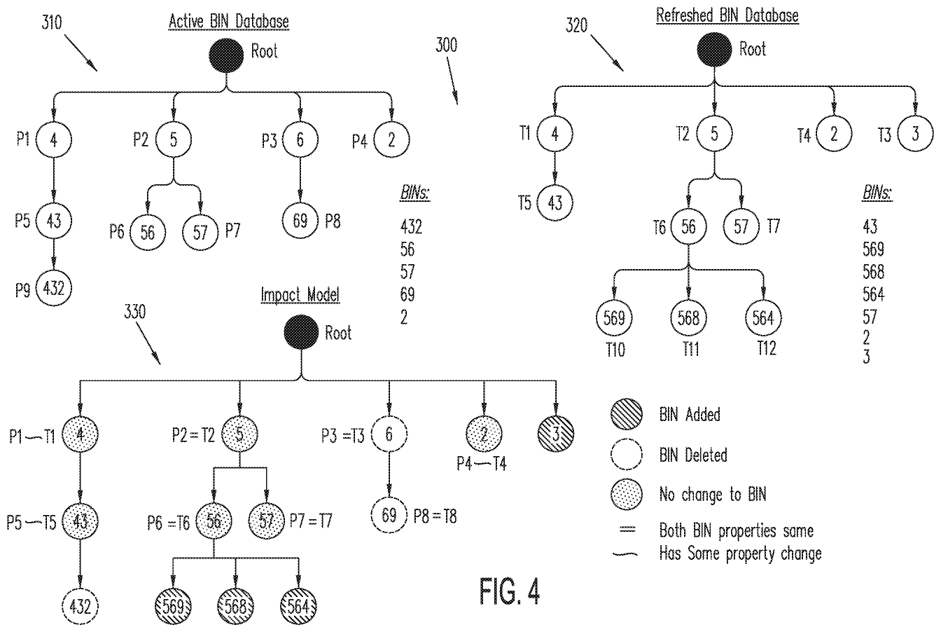

Regardless of how the BIN information is received and/or processed by the BIN aggregator 210 (e.g., from a single partner or from multiple partners), the BIN assembler/miner module 270 includes an impact analysis sub-module 280 that may be utilized to analyze the impact of updating the BIN file according to the information sent by the BIN aggregator 210. In some embodiments, the impact analysis sub-module 280 may generator and/or otherwise access a tree model, for example a tree model 300 shown in FIG. 4. As the name implies, the tree model 300 includes BINs that are derived from nodes with parent-child relationships, which form different “branches” of a “tree”.

According to the example shown in FIG. 4, for an active BIN database 310 (e.g., a part of the previous BIN file received from a partner), it may include nodes 4, 5, 6, 2, 43, 56, 57, 69, and 432, that are all derived from a root node. The active BIN database 310 may store the BIN files that the payment provider is currently using to process transactions. In some embodiments, the BIN database 310 may be implemented as an embodiment of, or at least in part using, the payment database 195 of FIG. 1. The nodes 4, 5, 6, 2, 43, 56, 57, 69, and 432 have properties P1, P2, P3, P4, P5, P6, P7, P8, and P9, respectively. The node 4 is the parent node of the node 43 (e.g., the “4” is inherited), which is the parent node of node 432 (e.g., the “43” is inherited). The node 5 is the parent node of the node 56 and the node 57 (e.g., the value “5” is inherited). The node 6 is the parent node of 69 (e.g., the value “6” is inherited). The node 2 has no parent node or child node. In the illustrated embodiment, a node corresponding to the active BIN database 310 constitutes a valid BIN only if the node is located at the “end” of a “tree branch.” In other words, a node is considered to represent a valid BIN only if the node does not have any child nodes. For instance, only the nodes 432, 56, 57, 69, and 2 constitute valid BINs for the active BIN database 310. Each of the BINs here may represent one of the BINs in FIG. 3. For example, each of the BINs herein may represent a portion of a credit card number, or a portion of a bank account number, or a country code, or a currency code, etc.

A refreshed BIN database 320 reflects the new BIN file received from the partner. The refreshed BIN database 320 may store updated BIN files (e.g., updated based on input received from the partners) that the payment provider should be using to process transactions. In FIG. 4, the refreshed BIN database 320 may include nodes 4, 5, 2, 43, 56, 57, 569, 568, 564, and 3 (all derived from a root node), respectively. The nodes 4, 5, 2, 43, 56, 57, 569, 568, 564, and 3 have properties T1, T2, T4, T5, T6, T7, T10, T11, T12, and T13, respectively. The node 4 is the parent node of the node 43 (e.g., the “4” is inherited). The node 5 is the parent node of the nodes 56 and 57 (e.g., the “5” is inherited). The node 56 is the parent node of the nodes T10, T11, and T12 (e.g., the “56” is inherited). The node 2 and the node 3 have no parent node or child node. Since a node constitutes a valid BIN only if the node is located at the “end” of the “tree branch,” only the BINs 43, 569, 568, 564, 57, 2, and 3 constitute valid bins for the refreshed BIN database 320.

Based on the changes from the active BIN database 310 to the refreshed BIN database 320, the tree model 300 generates an impact model 330. As can be seen from the impact model 330, the BINs 432 and 69 are deleted, the BINs 569, 568, 564, and 3 are added, while the BINs 56, 57, and 2 remain the same. Some of the nodes undergo a property change from the active BIN database 310 to the refreshed BIN database 320. For example, the nodes 4, 43, and 2 each undergo a property change from the active BIN database 310 to the refreshed BIN database 320. As non-limiting examples, the property changes may include: a change in currency code (e.g., USD to EUR), a change in country code (e.g., from US to UK), a change in card usage (e.g., credit to debit), etc. Other nodes may have no property changes from the active BIN database 310 to the refreshed BIN database 320. For example, the nodes 5, 56, 57, 6, and 69 undergo no property changes from the active BIN database 310 to the refreshed BIN database 320.

According to the various aspects of the present disclosure, the BINs that are not affected by the BIN update (e.g., neither added or deleted or have its property changed) can be immediately applied, since applying them should entail no risk. In some embodiments, these unaffected BINs can be sent to a BIN database 310 of the system 200, which may be an electronic database. The BIN database 310 may store the latest BIN information associated with each of the partners. Transactions may be conducted by retrieving the BIN data from the BIN database 310. In this manner, “normal” or “safe” BIN updates can be applied quickly without being held up by other problematic BIN updates that require further scrutiny.

On the other hand, the BIN additions, BIN deletions, or BIN property changes may each have a corresponding significant impact for users and/or total payment volume (TPV). To fully assess the impact of these updates (e.g., determined by the tree model 300 discussed above), the BIN assembler/miner module 270 uses a scoring sub-module 370 to calculate and assign a risk score for each potential update, be it a BIN addition, a BIN deletion, or a BIN property change. The scoring sub-module 370 may evaluate a plurality of attributes, such as what type of BIN property is changed, how much the TPV will be affected by the BIN update, and/or how many users will be affected by the BIN update.

For example, a change in currency code may be considered a high risk update. As another example, a change in country code may also be considered a high risk update. As yet another example, a BIN update that affects 1 to 100 users may be considered a no risk update, a BIN update that affects 100 to 1,000 users may be considered a low risk update, a BIN update that affects 1,000 to 50,000 users may be considered a medium risk update, and a BIN update that affects more than 50,000 users may be considered a high risk update. As a further example, a BIN update that impacts a TPV of $1 to $100 may be considered a no risk update, a BIN update that impacts a TPV of $100 to $1,000 may be considered a low risk update, a BIN update that impacts a TPV of $1,000 to $100,000 may be considered a medium risk update, and a BIN update that impacts a TPV of more than $100,000 may be considered a high risk update. It will be appreciated that different combinations of these attributes may yield different risk levels.

In some embodiments, the scoring sub-module 370 assigns weighted scores. For example, a no risk update may be assigned a risk score of 0, a low risk update may be assigned a risk score of 1, a medium risk update may be assigned a risk score of 2, and a high risk update may be assigned a risk score of 3. Consider the following hypothetical scenario: a BIN update may impact a TPV of $500 and 2,000 users. The TPV of $500 falls into a low risk category and therefore receives a risk score of 1. The total user of 2,000 falls into a medium risk category and therefore receives a risk score of 2. In this case, the TPV amount affected and the number of users affected may each be weighed a 50% of the total risk score. As such, the final risk score of the hypothetical BIN update can be calculated as 50%*1+50%*2=1.5, which indicates the BIN update as having a low-medium risk.

In another hypothetical scenario, a BIN update may impact a TPV of $50,000 and 51,000 users. The TPV of $50,000 falls into a medium risk category and therefore receives a risk score of 2. The total user of 51,000 falls into a high risk category and therefore receives a risk score of 3. In this case, the TPV amount affected and the number of users affected may each be weighed a 50% of the total risk score. As such, the final risk score of the hypothetical BIN update can be calculated as 50%*2+50%*3=2.5, which indicates the BIN update as having a medium-high risk.

It is understood that the weighting does not need to be split evenly (e.g., 50%/50% for 2 attributes or 25%/25%/25%/25% for 4 attributes). In some embodiments, certain attributes may be weighed more heavily than other attributes (e.g., a 70%/30% weighting). It is also understood that although only two attributes (TPV and number of users) are used to illustrate the weighted risk score, more than two attributes may be used to calculate the weighted risk score as well. In any case, once the total weighted risk score is calculated, the scoring sub-module 370 may compare the calculated weighted risk score with a predetermined threshold. In some embodiments, if the calculated weighted risk score is below the predetermined threshold, the BIN update may be deemed safe, and the BIN assembler/miner module 270 may update the BIN database 310 accordingly, and thereafter the BIN update may be automatically applied for transactions involving the payment provider. However, of the calculated weighted risk score exceeds the predetermined threshold, the BIN update may be deemed too risky, and the BIN assembler/miner module 270 may conduct further analysis on the BIN update. For example, the BIN assembler/miner module 270 may send the “risky” BIN update back to the partner that sent the update and request the partner confirm the accuracy of the BIN update.

The BIN assembler/miner module 270 may further include a conflict resolution sub-module 380, which may be used to resolve conflicts from different BIN updates. As a simplified example, a BIN update received from partner 1 may specify that the currency code for a particular BIN is in EUR (Euros), but another BIN update received from partner 2 may specify that the currency code for this particular BIN is in USD (U.S. dollars). As such, these two BIN updates are conflicting with one another and cannot both be applied. The conflict resolution sub-module 380 will include a list of rules to determine how to resolve BIN update conflicts such as the one discussed above.

For example, one of the rules of the sub-module 380 may stipulate that the issuer of the card (from which the BIN update came) will have the priority in BIN updates. Suppose the partner 1 in the above example is the issuer of the card, then the conflict resolution sub-module 380 will disregard the BIN update from partner 2 in favor of the BIN update from partner 1. As another example, a parent BIN and a child BIN (see FIG. 4) may have conflicting properties such as country code. A rule may stipulate that the parent BIN always has priority over a child BIN, in which case the property of the parent BIN may override the property of the child BIN. It is understood that a plurality of different rules may be applied to the same set of conflicting BIN updates, and each rule may involve more than one attribute. In the end, a final priority score may be calculated for each possible BIN update, and the conflict resolution sub-module 380 may submit the BIN update having the highest priority score as the BIN update to be applied.

It is understood that although two modules 210 and 270 are illustrated in FIG. 2, the system may include additional modules that may perform additional operations that are not specifically discussed herein for reasons of simplicity. Moreover, it is understood that the modules 210 and 270 may be partially or wholly merged in other embodiments, such that some of the tasks performed by the module 210 discussed above may be performed by the module 270, or that some of the tasks performed by the module 270 discussed above may be performed by the module 210. Each of the modules 210 and 270 may also be split up into a plurality of different modules, which may perform a portion of the tasks discussed above in association with the modules 210 or 270. Likewise, the sub-modules 280, 370, and 380 within the module 270 may also be integrated or further sub-divided, and additional sub-modules may be included within the module 270 for performing additional tasks.

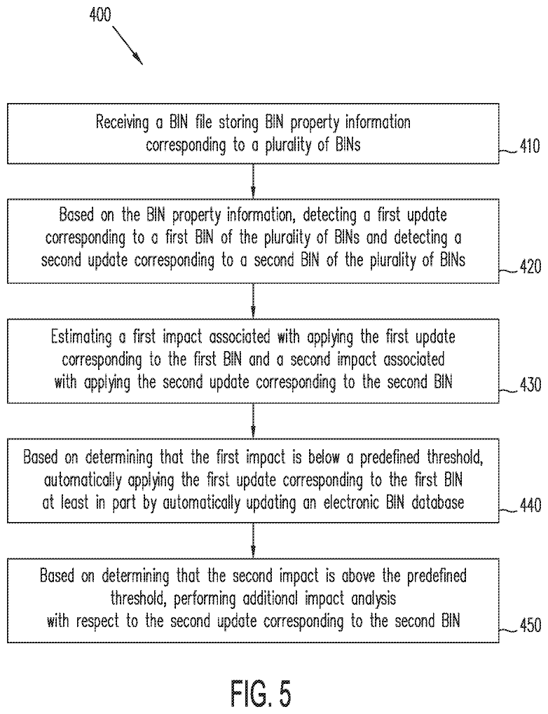

FIG. 5 is a flowchart illustrating a method 400 for updating BIN information according to various aspects of the present disclosure. The method 400 includes a step 410 of receiving a BIN file storing BIN property information corresponding to a plurality of BINs.

The method 400 includes a step 420 of detecting, based on the BIN property information, a first update corresponding to a first BIN of the plurality of BINs and a second update corresponding to a second BIN of the plurality of BINs. In some embodiments, the detecting comprises detecting an addition of the first BIN or the second BIN as a newly added BIN, detecting a deletion of the first BIN or the second BIN, or detecting a change in property of the first BIN or the second BIN. In some embodiments, the BIN property information comprises at least one of: a country, a currency, a payment network, a card issuer name, an issuer website, an issuer phone number, or a card usage type.

The method 400 includes a step 430 of estimating a first impact associated with applying the first update corresponding to the first BIN and a second impact associated with applying the second update corresponding to the second BIN. In some embodiments, the estimating comprises calculating a first risk score for the first impact and a second risk score for the second impact. In some embodiments, the calculating is based on a plurality of weighted attributes. In some embodiments, the calculating comprises weighing the weighted attributes unevenly.

The method 400 includes a step 440 of, based on determining that the first impact is below a predefined threshold, automatically applying the first update corresponding to the first BIN at least in part by automatically updating an electronic BIN database.

The method 400 includes a step 450 of performing additional impact analysis with respect to the second update corresponding to the second BIN based on determining that the second impact is above the predefined threshold.

In some embodiments, the BIN file is received from a first source. In some embodiments, the detecting comprises comparing the received BIN file with a previous version of the BIN file received from the first source. In some embodiments, the estimating the impact comprises estimating the first impact and the second impact against BIN property information previously stored in association with the previous version of the BIN file. In some embodiments, the detecting comprises comparing the received BIN file against one or more other BIN files received from one or more second sources different from the first source. In some embodiments, the estimating the impact comprises estimating the first impact and the second impact against BIN property information in the one or more other BIN files. In some embodiments, the estimating comprises giving different priorities to the BIN property information from the first source and the BIN property information from the one or more second sources.

It is understood that additional method steps may be performed before, during, or after the steps 410-450 discussed above. For reasons of simplicity, however, these additional steps are not discussed in detail herein.

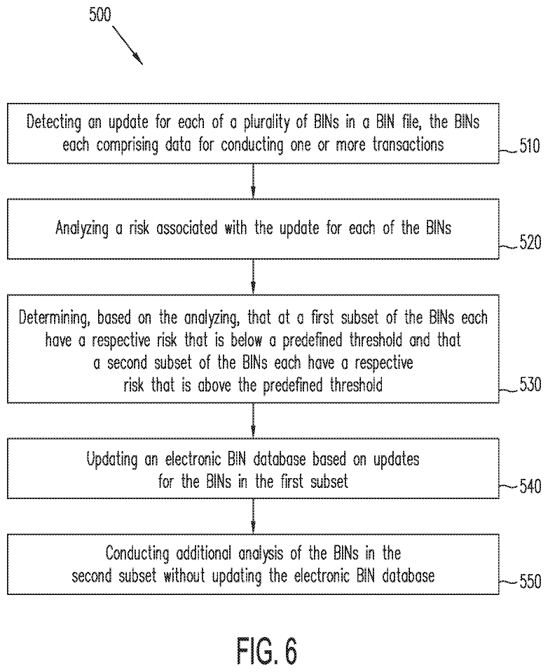

FIG. 6 is a flowchart illustrating a method 500 for updating BIN information according to various aspects of the present disclosure. The method 500 includes a step 510 of detecting an update for each of a plurality of BINs in a BIN file, the BINs each comprising data for conducting one or more transactions.

The method 500 includes a step 520 of analyzing a risk associated with the update for each of the BINs.

The method 500 includes a step 530 of determining, based on the analyzing, that at a first subset of the BINs each have a respective risk that is below a predefined threshold and that a second subset of the BINs each have a respective risk that is above the predefined threshold.

The method 500 includes a step 540 of updating an electronic BIN database based on updates for the BINs in the first subset.

The method 500 includes a step 550 of conducting additional analysis of the BINs in the second subset without updating the electronic BIN database.

In some embodiments, the method 500 further includes a step of receiving the BIN file from a first financial entity. In some embodiments, the detecting comprises comparing the received BIN file with a previous version of the BIN file received from the financial entity or against other BIN files received from one or more second financial entities. In some embodiments, the detecting comprises detecting an addition of one or more BINs, a deletion of one or more BINs, or a change in a property of one or more BINs.

It is understood that additional method steps may be performed before, during, or after the steps 510-550 discussed above. For reasons of simplicity, however, these additional steps are not discussed in detail herein.

Based on the above discussions, it can be seen that the present disclosure offers several significant advantages over conventional methods and systems. It is understood, however, that not all advantages are necessarily discussed in detail herein, different embodiments may offer different advantages, and that no particular advantage is required for all embodiments. One advantage is improved functionality of a computer. For example, by implementing the BIN updates in a more granular manner—as opposed to the all-or-nothing-conventional approach—the present disclosure allows the no-risk and low-risk BIN updates to be applied automatically. The automatic application of the no-risk or low-risk BIN updates frees up system resources, which were held up under conventional schemes until every questionable BIN update has been resolved. As such, the present disclosure entails faster and more efficient computing. Another advantage is that the prompt application of the BIN updates helps ensure that the most up-to-date BIN information is used for transactions. Yet another advantage is that the present disclosure ensures the accuracy and integrity of the BIN information via its BIN update impact analysis, risk score calculations, and conflict resolutions. In other words, problematic or erroneous BIN updates can be quickly identified, assessed, and/or corrected. The various aspects of the present disclosure are also compatible with existing process flow and do not require extensive hardware or software modifications, and thus the present disclosure is cheap to implement.

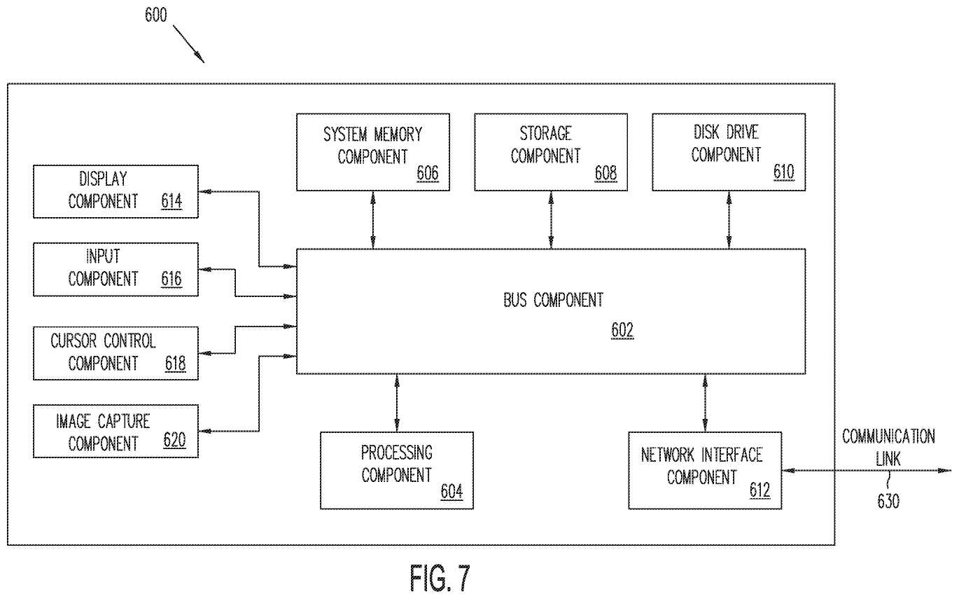

FIG. 7 is a block diagram of a computer system 600 suitable for implementing various methods and devices described herein, for example, the modules 210 and 270 (or the sub-modules 280, 370, and 380) and the various method steps of the methods 400 and 500. In various implementations, the devices capable of performing the steps may comprise a network communications device (e.g., mobile cellular phone, laptop, personal computer, tablet, etc.), a network computing device (e.g., a network server, a computer processor, an electronic communications interface, etc.), or another suitable device. Accordingly, it should be appreciated that the devices capable of implementing the modules 210 and 270 (or the sub-modules 280, 370, and 380) and the various method steps of the methods 400 and 500 may be implemented as the computer system 600 in a manner as follows.

In accordance with various embodiments of the present disclosure, the computer system 600, such as a network server or a mobile communications device, includes a bus component 602 or other communication mechanisms for communicating information, which interconnects subsystems and components, such as a computer processing component 604 (e.g., processor, micro-controller, digital signal processor (DSP), etc.), system memory component 606 (e.g., RAM), static storage component 608 (e.g., ROM), disk drive component 610 (e.g., magnetic or optical), network interface component 612 (e.g., modem or Ethernet card), display component 614 (e.g., cathode ray tube (CRT) or liquid crystal display (LCD)), input component 616 (e.g., keyboard), cursor control component 618 (e.g., mouse or trackball), and image capture component 620 (e.g., analog or digital camera). In one implementation, disk drive component 610 may comprise a database having one or more disk drive components.

In accordance with embodiments of the present disclosure, computer system 600 performs specific operations by the processor 604 executing one or more sequences of one or more instructions contained in system memory component 606. Such instructions may be read into system memory component 606 from another computer readable medium, such as static storage component 608 or disk drive component 610. In other embodiments, hard-wired circuitry may be used in place of (or in combination with) software instructions to implement the present disclosure.

Logic may be encoded in a computer readable medium, which may refer to any medium that participates in providing instructions to the processor 604 for execution. Such a medium may take many forms, including but not limited to, non-volatile media and volatile media. In one embodiment, the computer readable medium is non-transitory. In various implementations, non-volatile media includes optical or magnetic disks, such as disk drive component 610, and volatile media includes dynamic memory, such as system memory component 606. In one aspect, data and information related to execution instructions may be transmitted to computer system 600 via a transmission media, such as in the form of acoustic or light waves, including those generated during radio wave and infrared data communications. In various implementations, transmission media may include coaxial cables, copper wire, and fiber optics, including wires that comprise bus 602.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 630 (e.g., a communications network, such as a LAN, WLAN, PTSN, and/or various other wired or wireless networks, including telecommunications, mobile, and cellular phone networks) may perform instruction sequences to practice the present disclosure in coordination with one another.

Computer system 600 may transmit and receive messages, data, information and instructions, including one or more programs (i.e., application code) through communication link 630 and communication interface 612. Received program code may be executed by computer processor 604 as received and/or stored in disk drive component 610 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as computer program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

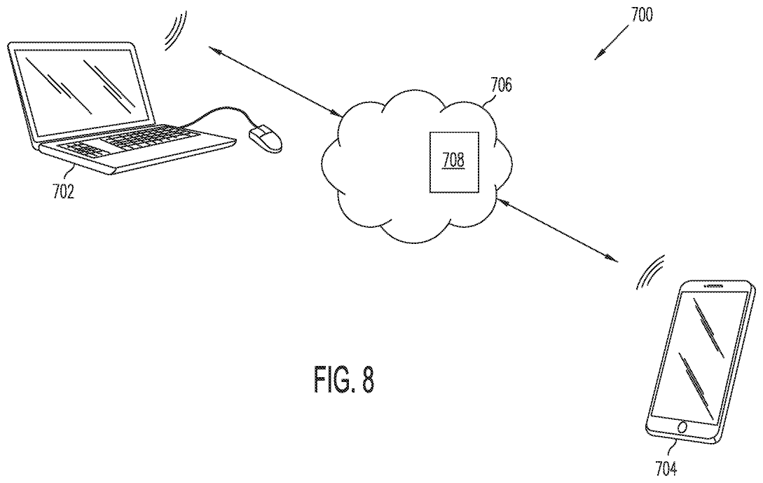

FIG. 8 illustrates an example cloud-based computing architecture 700, which may also be used to implement various aspects of the present disclosure. The cloud-based computing architecture 700 includes a mobile device 704 and a computer 702, both connected to a computer network 706 (e.g., the Internet or an intranet). In one example, a consumer has the mobile device 704 that is in communication with cloud-based resources 708, which may include one or more computers, such as server computers, with adequate memory resources to handle requests from a variety of users. A given embodiment may divide up the functionality between the mobile device 704 and the cloud-based resources 708 in any appropriate manner. For example, an app on mobile device 704 may perform basic input/output interactions with the user, but a majority of the processing and caching may be performed by the cloud-based resources 708. However, other divisions of responsibility are also possible in various embodiments.

The cloud-based computing architecture 700 also includes the personal computer 702 in communication with the cloud-based resources 708. In one example, a participating merchant or consumer/user may access information from the cloud-based resources 708 by logging on to a merchant account or a user account at computer 702. The system and method for updating the BIN information discussed above may be implemented at least in part based on the cloud-based computing architecture 700.

It is understood that the various components of cloud-based computing architecture 700 are shown as examples only. For instance, a given user may access the cloud-based resources 708 by a number of devices, not all of the devices being mobile devices. Similarly, a merchant or another user may access resources 708 from any number of suitable mobile or non-mobile devices. Furthermore, the cloud-based resources 708 may accommodate many merchants and users in various embodiments.

It should be appreciated that like reference numerals are used to identify like elements illustrated in one or more of the figures, wherein these labeled figures are for purposes of illustrating embodiments of the present disclosure and not for purposes of limiting the same.

One aspect of the present disclosure involves a method. The method includes: receiving a BIN file storing BIN property information corresponding to a plurality of BINs; based on the BIN property information, detecting a first update corresponding to a first BIN of the plurality of BINs and detecting a second update corresponding to a second BIN of the plurality of BINs; estimating a first impact associated with applying the first update corresponding to the first BIN and a second impact associated with applying the second update corresponding to the second BIN; based on determining that the first impact is below a predefined threshold, automatically applying the first update corresponding to the first BIN at least in part by automatically updating an electronic BIN database; and based on determining that the second impact is above the predefined threshold, performing additional impact analysis with respect to the second update corresponding to the second BIN.

Another one aspect of the present disclosure involves a system that includes a non-transitory memory and one or more hardware processors coupled to the non-transitory memory and configured to read instructions from the non-transitory memory to cause the system to perform operations comprising: receiving a BIN file storing BIN property information corresponding to a plurality of BINs, the bins each comprising data for conducting one or more transactions; based on the BIN property information, detecting a first update corresponding to a first BIN of the plurality of BINs and detecting a second update corresponding to a second BIN of the plurality of BINs; estimating a first impact associated with applying the first update corresponding to the first BIN and a second impact associated with applying the second update corresponding to the second BIN; based on determining that the first impact is below a predefined threshold, automatically applying the first update corresponding to the first BIN at least in part by automatically updating the electronic database; and based on determining that the second impact is above the predefined threshold, performing additional impact analysis with respect to the second update corresponding to the second BIN.

Yet another aspect of the present disclosure involves a non-transitory machine-readable medium having stored thereon machine-readable instructions executable to cause a machine to perform operations comprising: detecting an update for each of a plurality of BINs in a BIN file, the BINs each comprising data for conducting one or more transactions; analyzing a risk associated with the update for each of the BINs; determining, based on the analyzing, that at a first subset of the BINs each have a respective risk that is below a predefined threshold and that a second subset of the BINs each have a respective risk that is above the predefined threshold; updating an electronic BIN database based on updates for the BINs in the first subset; and conducting additional analysis of the BINs in the second subset without updating the electronic BIN database.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method, comprising:
receiving a bank identification number (BIN) file storing BIN property information corresponding to a plurality of BINs;
based on the BIN property information, detecting a first update corresponding to a first BIN of the plurality of BINs and detecting a second update corresponding to a second BIN of the plurality of BINs;
estimating a first impact associated with applying the first update corresponding to the first BIN and a second impact associated with applying the second update corresponding to the second BIN;
based on determining that the first impact is below a predefined threshold, automatically applying the first update corresponding to the first BIN at least in part by automatically updating an electronic BIN database; and
based on determining that the second impact is above the predefined threshold, performing additional impact analysis with respect to the second update corresponding to the second BIN.

2. The method of claim 1, wherein the detecting comprises detecting an addition of the first BIN or the second BIN as a newly added BIN, detecting a deletion of the first BIN or the second BIN, or detecting a change in property of the first BIN or the second BIN.

3. The method of claim 1, wherein the estimating comprises calculating a first risk score for the first impact and a second risk score for the second impact.

4. The method of claim 3, wherein the calculating is based on a plurality of weighted attributes.

5. The method of claim 4, wherein the calculating comprises weighing the weighted attributes unevenly.

6. The method of claim 1, wherein the BIN file is received from a first source, and wherein the detecting comprises comparing the received BIN file with a previous version of the BIN file received from the first source.

7. The method of claim 6, wherein the estimating comprises estimating the first impact and the second impact against BIN property information previously stored in association with the previous version of the BIN file.

8. The method of claim 1, wherein the BIN file is received from a first source, and wherein the detecting comprises comparing the received BIN file against one or more other BIN files received from one or more second sources different from the first source.

9. The method of claim 8, wherein the estimating comprises estimating the first impact and the second impact against BIN property information in the one or more other BIN files.

10. The method of claim 8, wherein the estimating comprises giving different priorities to the BIN property information from the first source and the BIN property information from the one or more second sources.

11. The method of claim 1, wherein the BIN property information comprises at least one of: a country code, a currency code, a payment network, a card issuer name, or a card usage type.

12. A system, comprising:
an electronic database;
a non-transitory memory; and
one or more hardware processors coupled to the non-transitory memory and configured to read instructions from the non-transitory memory to cause the system to perform operations comprising:
receiving a bank identification number (BIN) file storing BIN property information corresponding to a plurality of BINs, the bins each comprising data for conducting one or more transactions;
based on the BIN property information, detecting a first update corresponding to a first BIN of the plurality of BINs and detecting a second update corresponding to a second BIN of the plurality of BINs;
estimating a first impact associated with applying the first update corresponding to the first BIN and a second impact associated with applying the second update corresponding to the second BIN;
based on determining that the first impact is below a predefined threshold, automatically applying the first update corresponding to the first BIN at least in part by automatically updating the electronic database; and
based on determining that the second impact is above the predefined threshold, performing additional impact analysis with respect to the second update corresponding to the second BIN.

13. The system of claim 12, wherein the detecting comprises detecting an addition of the first BIN or the second BIN as a newly added BIN, detecting a deletion of the first BIN or the second BIN, or detecting a change in property of the first BIN or the second BIN.

14. The system of claim 12, wherein the estimating comprises calculating a first risk score for the first impact and a second risk score for the second impact based on a plurality of weighted attributes.

15. The system of claim 14, wherein the calculating comprises weighing the weighted attributes unevenly.

16. The system of claim 12, wherein the BIN file is received from a first source, and wherein the detecting comprises comparing the received BIN file with a previous version of the BIN file received from the first source or against one or more other BIN files received from one or more second sources different from the first source.

17. The system of claim 16, wherein the estimating comprises estimating the first impact and the second impact against BIN property information previously stored in association with the previous version of the BIN file or against BIN property information in the one or more other BIN files.

18. The system of claim 16, wherein the estimating comprises prioritizing the BIN property information from the first source and the BIN property information from the one or more second sources differently.

19. A non-transitory machine-readable medium having stored thereon machine-readable instructions executable to cause a machine to perform operations comprising:
detecting an update for each of a plurality of bank identification numbers (BINs) in a BIN file, the BINs each comprising data for conducting one or more transactions;
analyzing a risk associated with the update for each of the BINs;
determining, based on the analyzing, that at a first subset of the BINs each have a respective risk that is below a predefined threshold and that a second subset of the BINs each have a respective risk that is above the predefined threshold;
updating an electronic BIN database based on updates for the BINs in the first subset; and
conducting additional analysis of the BINs in the second subset without updating the electronic BIN database.

20. The non-transitory machine-readable medium of claim 19, wherein the detecting comprises detecting an addition of one or more BINs, a deletion of one or more BINs, or a change in a property of one or more BINs, wherein the operations further comprise: receiving the BIN file from a first financial entity, wherein the detecting comprises comparing the received BIN file with a previous version of the BIN file received from the first financial entity or against other BIN files received from one or more second financial entities.
